(19) United States
(12) Patent Application Publication
(10) Pub. No.: US 2004/0253153 A1
(43) Pub. Date: Dec. 16, 2004

(54) Travelizer

(76) Inventor: Robert Carmen Barone, Rancho Mirage, CA (US)

Correspondence Address: ROBERT BARONE, 134 LA CERRA DR., RANCHO MIRAGE, CA, 92270, US

(21) Appl. No.: 10/459,134

(22) Filed: Jun. 12, 2003

(51) Int. Cl. B32B 5/02

(52) U.S. Cl. 422/123; 422/120

(57) ABSTRACT

The “Travelizer” utilizes an already existing disinfectant spray, such as Lysol®, and incorporates said spray into a portable canister.

### CROSS REFERENCE TO RELATED APPLICATIONS

This nonprovisional utility patent application does not claim the benefit of one or more prior filed copending nonprovisional applications.

### COPYRIGHT STATEMENT

This nonprovisional utility patent application is intended to be used with but not limited to Lysol® brand disinfectant spray.

### BACKGROUND OF INVENTION

Lysol®, and other similarly situated products, are widely used in domestic and commercial settings for sanitary purposes in the killing of some viruses, bacteria, mold, and mildew. However, the canisters are not portable, and as a result, most consumers do not carry them on outings etc. Due to the presence of the above-mentioned germs in such places as public restrooms and public telephones, as well as many others, I have come up with the idea of creating a portable canister of Lysol® that can be carried by the consumer, and used where he feels it is needed.

### SUMMARY OF INVENTION

The “Travelizer” is a portable spray canister of Lysol®, or a similarly situated product, with a key chain attachment for an optional means of carry.

### BRIEF DESCRIPTION OF DRAWINGS

FIG. 1: This figure depicts the “Travelizer” from a side view. The unit would be cylindrical in shape, and stand 3-inches in height total, with 0.75-inches allotted to the cap, and 2.25-inches allotted to the canister itself. The unit would measure 0.75-inches in diameter. The unit also has a key chain base, to which is connected a key chain attachment.

FIG. 2: This figure depicts the “Travelizer” from a top view. The 0.75-inch diameter is shown, along with the aerosol trigger. The key chain attachment can be seen extending from the bottom of the unit.

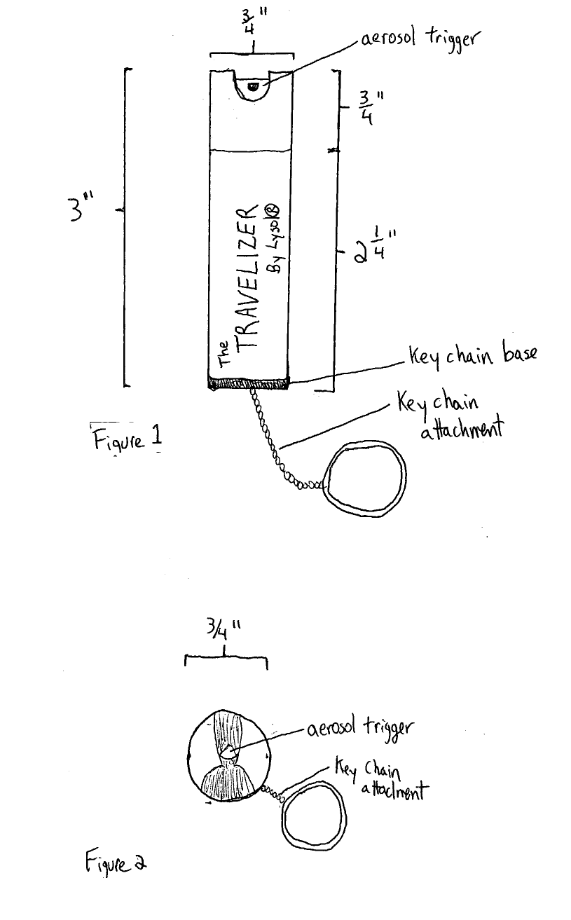

### DETAILED DESCRIPTION

The “Travelizer” encompasses the Lysol® product, or similarly situated product, in a portable spray unit. It is to be manufactured in the same process as the original Lysol® or similarly situated product.

1. What I claim as my invention is: A portable Lysol®, or similarly situated product, spray unit, for the purpose of sanitizing surfaces according to the claims of the Lysol® or similarly situated product. Due to its portable nature, the “Travelizer” could be carried and used anywhere the consumer desires to sanitize a surface.
